(19) United States
(12) Patent Application Publication
(10) Pub. No.: US 2005/0174071 A1
(43) Pub. Date: Aug. 11, 2005

(54) Transposed bi-directional scanning in a cathode ray tube

(76) Inventor: Theodore Frederick Simpson, Lancaster, PA (US)

Correspondence Address: THOMSON LICENSING INC., PATENT OPERATIONS, PO BOX 5312, PRINCETON, NJ, 08543-5312, US

(21) Appl. No.: 10/509,948

(22) PCT Filed: Apr. 3, 2003
(86) PCT No.: PCT/US03/10183

Related U.S. Application Data
(60) Provisional application No. 60/369,928, filed on Apr. 4, 2002.

(51) Int. Cl. G09G 1/04

(52) U.S. Cl. 315/364

(57) ABSTRACT

A video display includes a transposed scanning system. The transposed scanning system utilizes sinusoidal scanning to provide bi-directional scanning along a short axis of a display screen of a cathode ray tube. Therefore, the more difficult to achieve, higher frequency scan task is assigned to the short axis requiring the least deflection energy.

### CROSS REFERENCE TO RELATED APPLICATIONS

This is a non-provisional application which claims the benefit of provisional application Ser. No. 60/369,928, filed Apr. 4, 2002.

The invention relates to a deflection circuit of a video display.

### BACKGROUND OF THE INVENTION

Entertainment television and computer systems commonly use a cathode ray tube (CRT) display to present pictures and information to the viewer. The CRT screen is approximately rectangular in shape, usually having an aspect ratio of approximately 4 by 3 or 16 by 9, as shown in FIGS. 3, and 4, respectively. The aspect ratio is defined as the ratio of the long axis X to the short axis Y of the screen. Typically, the screen is raster scanned with high frequency scanning in parallel with the long axis of the screen, which is usually oriented in the horizontal direction X. Horizontal scanning is obtained by a sawtooth deflection current provided by a switched resonant circuit.

The low frequency of scan, sometimes referred to as the “refresh rate”, is applied parallel to the short axis of the tube, which is usually oriented in the vertical direction Y. The short axis or vertical scanning is obtained by a sawtooth deflection current provided by a quasi-linear amplifier, often with the addition of a switched resonant component to provide a rapid retrace.

A television receiver receives and processes an incoming video signal containing numerous horizontal video lines. The information contained in a given video line is displayed in scan lines forming a field. Each field includes a number of scan lines.

FIG. 1 illustrates a display screen 222 having a 4 by 3 aspect ratio. The long axis of screen 222 is parallel to axis X; whereas, the short axis of screen 222 is parallel to axis Y.

Solid lines 222a within screen 222 are active scan lines that display information produced by an electron beam, not shown, traveling from left to right. Broken lines 222a represent invisible retrace lines, when the electron beam is blanked off. If the beam were not blanked, the beam would have traveled from right to left to start of next active scan line. For illustration purposes, only five lines 222a are shown. Vertical retrace, which occupies the period of several horizontal scan intervals, is not shown for clarity. Vertical separation of lines 222a is exaggerated for illustrative purposes. Also, progressive scan is shown for clarity.

Typically, a picture is formed of scan lines 222a that are substantially horizontally scanned from left to right, for example, on CRT display screen 222, as explained before. Picture information is assigned to elements of horizontally scanned lines 222a. Horizontal scan lines 222a are successively scanned from top to bottom so that a predetermined number of horizontal lines form the field.

In an arrangement not shown, a frame includes, for example, two fields for interlaced scan, or a single field for progressive scan. For example, according to the European television broadcasting standard (PAL), a frame is composed of 2 interlaced fields of 312.5 lines each, the field frequency being 50 Hz and the line frequency being 15,625 Hz.

To shorten the length of CRT's, higher deflection angles, for example, 130 degrees, have been implemented. Additionally, higher scan rates are required. These higher scan rates and higher deflection angles lead to demands for faster switching devices in the horizontal deflection circuit while incurring higher power dissipation and expense in the switching devices.

U.S. Pat. No. 4,634,940, entitled SINE WAVE DEFLECTION CIRCUIT FOR BIDRECTIONAL SCANNING OF A CATHODE RAY TUBE, in the name of Groeneweg, et al., describes a capacitively coupled square wave generator that provides a steady state sinusoidal current flow in a horizontal deflection winding of a CRT. The deflection winding and an additional capacitor form a tank or tuned circuit which filters out the odd harmonics of the square wave generator to provide a sinusoidal current in the deflection winding that enables bi-directional horizontal scanning. The term bi-directional horizontal scanning refers to a scanning technique in which video information is displayed both when the electron beam moves in one direction, parallel to axis X, and in the opposite direction, parallel to axis X.

Video signal is applied to the CRT in both forward and reverse directions of scan, as the tuned circuit “rings” with a sine-Wave of scan current, not shown.

FIG. 2 illustrates a display screen 223 having a 16 by 9 aspect ratio. The long axis of screen 223 is parallel to axis X; whereas, the short axis of screen 223 is parallel to axis Y. All scan lines 223a within screen 223 are active scan lines that display information produced by an electron beam, not shown, traveling from left to right then from right to left. For illustration purposes, only ten lines are shown. Vertical retrace, which occupies the period of several horizontal scan intervals, is not shown for clarity. Vertical separation of lines is exaggerated for illustrative purposes.

On the top line of scan, the beam might be swept from left to right parallel to the long axis X of the tube, and on the immediately following line, it would then be swept from right to left, as explained before. Such arrangement requires “reading out” video signal pixels of alternate video lines in forward or backward directions, respectively. The Groeneweg, et al. patent suggests storing pixels in a first in-first out memory (FIFO) for subsequent display, during the forward sweep, and in a last in-first out memory (LFO) for a subsequent display during the return sweep.

Sinusoidal scanning system has the advantage of sharply reducing the demands on the deflection device in the high-frequency scan circuit. This is so because in a system using sinusoidal deflection, the current flowing through the winding is primarily of the fundamental frequency of the driving current; whereas, in a fast flyback the harmonics contents are higher. The higher the harmonic contents of the deflection current, the higher is the power dissipated in the ferrite of the winding and the losses due to the skin effect.

U.S. Pat. No. 4,989,092, entitled PICTURE DISPLAY DEVICE USING SCAN DIRECTION TRANSPOSITION, in the names of Doyle et al. (the Doyle et al., patent) describes a transposed scanning system. In transposed scanning, the lines are scanned vertically, from the top of the picture, at the higher, line scanning frequency. The horizontal scanning occurs from left to right at the lower, field scanning frequency. Because of vertical line scanning, the high-frequency scanning is effected at a smaller scanning angle and thus at an amplitude which are smaller than the corresponding values for horizontal line scanning. Therefore, the dissipation is considerably reduced.

The Doyle et al., patent describes a scan direction transposition video processing circuit for receiving the picture information and for sequentially assigning picture information to elements of the vertically scanned lines. Thereby, the compatibility with the existing systems is maintained. The incoming picture information is written in a memory in the order of arrival, during one field period, while the picture information already stored in a second memory is being read out in a direction perpendicular to the write direction. Transposed scanning is also discussed in an article entitled, 36.2: Transposed Scanning: The Way to Realize Super-Slim CRTs, in the names of Krijn, et al., published in SID 01 DIGEST.

A transposed scanning system, embodying an inventive feature, utilizes sinusoidal scanning to provide a bi-directional scanning along the short axis Y of the CRT. Therefore, advantageously, the more difficult to achieve, higher-frequency scan task is assigned to the short axis requiring the least deflection energy. By implementing the high frequency direction of scan as a sinusoidal waveform, the electrical requirements are further eased. Because the limiting circuit function requirements are eased, the overall system can be made capable of providing either higher frequencies or wider deflection angles (or both) than would otherwise be possible.

In a horizontal sinusoidal scanning system, a timing offset between video lines, caused by, for example, jitter in the incoming video signal, can be, disadvantageously, spatially doubled. This arises when a given line, scanned from left to right, is displaced in one direction; and then the next line, scanned from right to left, is displaced in the other direction. Horizontal sinusoidal scanning system effectively doubles the magnitude of the disturbance. Thus, when signals containing timing jitter are played back, the line-to-line jitter is visually amplified by this reversal in scan. Consequently, a rapid timing jitter such as that caused by inexpensive, less-stable VCR's and other local signal generators might degrade performance.

The jitter vulnerability is reduced in the inventive transposed scanning system that utilizes sinusoidal scanning to provide a bidirectional vertical scanning along the short axis Y of the CRT. This is so because the vertical timing is less susceptible to jitter than the horizontal timing. The term bi-directional vertical scanning refers herein to the inventive scanning technique in which video information is displayed both when the electron beam moves in one direction, parallel to axis Y, and in the opposite direction, parallel to axis Y.

Moreover, advantageously, a common video processing hardware can be shared for obtaining both the transposed scanning feature and the sinusoidal scanning feature. This is so because to obtain each feature, the video has to be stored and “read out” in a different order than that in which it is transmitted and received.

### SUMMARY OF THE INVENTION

A video display deflection apparatus, embodying an inventive feature includes a cathode ray tube having a display screen with a shorter first axis and a longer second axis perpendicular to the first axis. A first deflection field generator produces a first deflection field in a beam path of an electron beam of the cathode ray tube at a first deflection frequency to vary a position of said electron beam, alternately, in a direction of the first axis and in a direction that is opposite to the first axis to provide for bidirectional scanning. A second deflection field generator produces a second deflection field in the beam path at a second deflection frequency lower than the first deflection frequency to vary a position of the electron beam, alternately, in a direction of the second axis and in a direction that is opposite to the second axis.

### BRIEF DESCRIPTION OF THE DRAWINGS

FIG. 1 illustrates a display screen with a prior art unidirectional scanning;

FIG. 2 illustrates a display screen with a prior art bi-directional scanning in the direction of the long axis;

FIGS. 3 and 4 illustrate a prior art display screen having corresponding aspect ratios;

FIG. 5 illustrates a display screen with a bidirectional scanning in the direction of the short axis, embodying an inventive feature; and

FIG. 6 illustrates a deflection circuit, embodying an inventive feature, for scanning an electron beam in the display screen of FIG. 5.

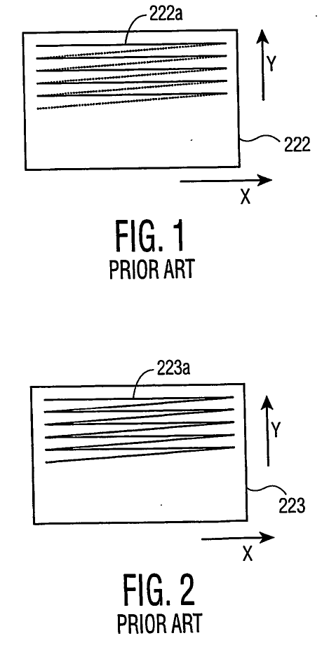

### DESCRIPTION OF THE PREFERRED EMBODIMENTS

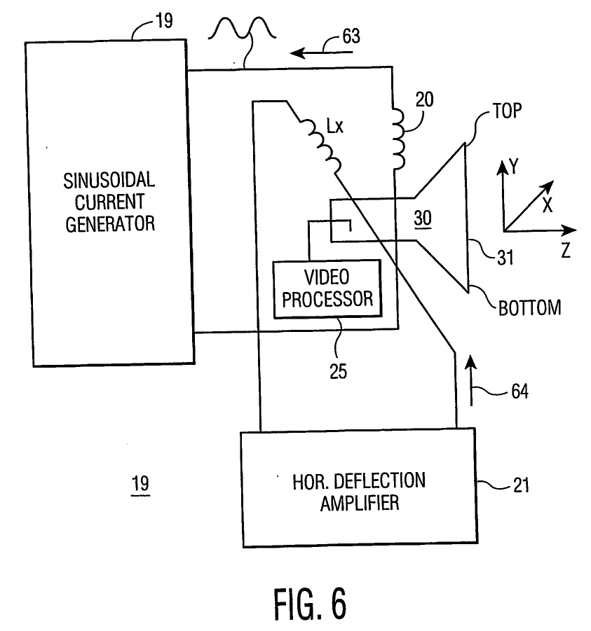

A bidirectional scanning, sinusoidal current generator 19, illustrated in FIG. 6, embodying an aspect of the invention, provides a sinusoidal-like periodic deflection current 63, through a vertical deflection winding 20. Current 63 effectuates transposed, bi-directional vertical scanning. The frequency of current 63 is, for example, approximately 15.75 kHz for an interlaced scan system or 31.5 kHz for a progressive scan system. Deflection winding 20 is used for directing the electron-beam in a cathode ray tube (CRT) 30 to cyclically move from the top of a screen 31 of the CRT 30 to the bottom and then back to the top in a cyclically sinusoidal manner. CRT 30 has a vertical axis Y that is shorter than a horizontal axis X to provide an aspect ration of 4 by 3 or 16 by 9, as shown in FIGS. 3 and 4, respectively.

Scanning circuit 19 may have a similar topology to that described in, for example, the Groeneweg, et al., patent. A main difference is that in the arrangement of FIG. 6 circuit 19 drives winding 20 that is a vertical deflection winding with sinusoidal current 63. In contrast to that, in the Groeneweg, et al. patent, a horizontal deflection winding is driven by sinusoidal current.

A field deflection amplifier 21 produces a sawtooth deflection current 64 through a horizontal deflection winding Lx for effectuating horizontal scanning. The frequency of current 64 is, for example, 60 Hz in the NTSC standard in the U.S.A or 50 Hz, in the PAL standard in Europe. Deflection winding Lx is used for directing the electron-beam in CRT 30 to move away from one side of screen 31 of the tube, during a trace interval, in a relatively slow manner and then back to the same side, in a relatively fast manner.

Deflection amplifier 21 may have a similar topology to that of a conventional vertical amplifier described in, for example, U.S. Pat. No. 5,587,631, entitled RESISTOR-ATCHED DEFLECTION APPARATUS FOR A VIDEO DISPLAY, in the names of Wilber, et al. A main difference is that, in the arrangement of FIG. 6, amplifier 21 drives winding Lx that is a horizontal deflection winding. In contrast to that, in the Wilber, et al., patent, the similarly constructed amplifier drives a vertical deflection winding.

A video processor 25 includes a video memory, not shown, for storing incoming video lines such as defined in, for example, the European Television Broadcasting Standard that arrives at an input, not shown, of video processor 25. One memory, not shown, of video processor 25 stores one full frame of pixel video. The already stored frame of pixel video in a second memory of processor 25 is being read out in a direction perpendicular to the write direction to generate vertical video lines, not shown, in a similar way to that described in the Doyle et al., patent, with the differences noted below. The vertical video lines, not shown, are applied to a video amplifier, not shown, for display in the direction of short axis Y of CRT 30.

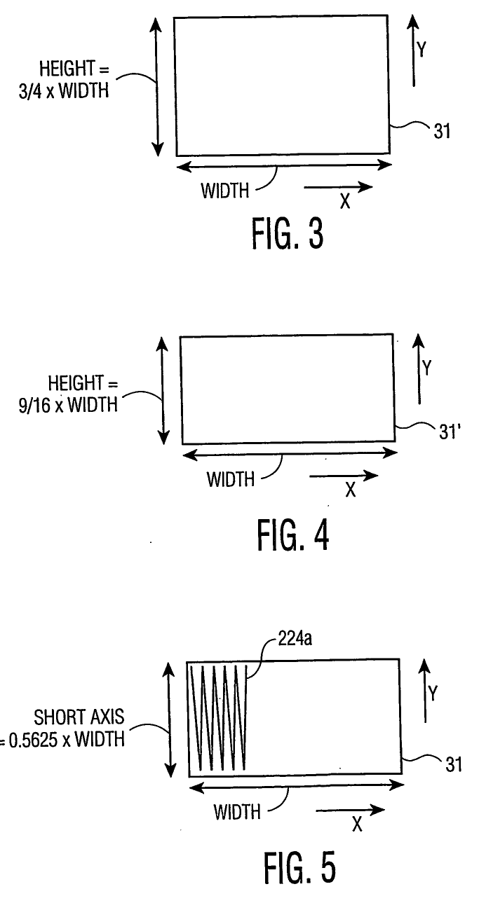

FIG. 5 illustrates display screen 31 of FIG. 6 having a 16 by 9 aspect ratio. The long axis of screen 31 is parallel to axis X; whereas, the short axis of screen 31 is parallel to axis Y. Similar symbols and numerals in FIGS. 5 and 6 indicate similar items or functions. All scan lines 224a of FIG. 5 within screen 31 are active scan lines that display information produced by an electron beam, not shown, traveling in both upward and downward directions along axis Y. For illustration purposes, only ten lines 224a are shown. Horizontal retrace, which occupies the period of several vertical scan intervals, is not shown for clarity. Horizontal separation of lines is exaggerated for better clarity.

The vertical video lines of processor 25 of FIG. 6 are read out and applied to the video amplifier, not shown, in the order, top-to-bottom, and bottom-to-top, alternately, in alternate scan lines 224a of FIG. 5, respectively. Thus, the vertical video lines of processor 25 of FIG. 6 provide for bi-directional vertical scanning. Successive vertical video lines 224a of FIG. 5 are displayed progressively in the left-to-right direction along long axis X of screen 31, as indicated before.

For wide angle deflection and/or flat screens, linearity correction of current 64 of FIG. 6 may be required in a similar manner, not shown, to that done in a conventional television receiver. For pincushion distortion correction (raster shape curvature parallel to the short axis), amplitude modulation of deflection current 64 may be required.

Bi-directional scanning causes scan lines to be spaced apart a non-uniform distance along short axis Y of scan, or too close together at the edges of the screen. This can be corrected, in a manner not shown, by step-scanning instead of using a gradually changing sawtooth current 64 throughout horizontal trace. A discrete or step increment of current 64 is provided at the end of each high frequency vertical scan line.

Alternatively, bidirectional scanning can be implemented in each of axes X and Y. Thus bi-directional scanning in the horizontal direction X can be implemented in addition to the aforementioned bi-directional scanning in the vertical direction Y. In this case, current 64 might also be a sinusoidal current. The advantage associated with sinusoidal current 64 is that the complexity associated in obtaining fast retrace is eliminated. In such a dual bidirectional mode of operation, video processor 25 would be accordingly modified.

1. A video display deflection apparatus, comprising:
a cathode ray tube having a display screen with a shorter first axis and a longer second axis perpendicular to said first axis;
a first deflection field generator for producing a first deflection field in a beam path of an electron beam of said cathode ray tube at a first deflection frequency to vary a position of said electron beam, alternately, in a direction of said first axis and in a direction that is opposite to said first axis to provide for bi-directional scanning; and
a second deflection field generator for producing a second deflection field in said beam path at a second deflection frequency lower than said first deflection frequency to vary a position of said electron beam, alternately, in a direction of said second axis and in a direction that is opposite to said second axis.

2. The video display deflection apparatus according to claim 1 wherein, in normal viewing, said first axis is disposed in a vertical direction with respect to a viewer.

3. A video display deflection apparatus according to claim 1 wherein at least one of said first and second deflection field generators comprises a deflection winding that produces a magnetic deflection field.

4. A video display deflection apparatus according to claim 1 wherein said first deflection field varies in a sinusoidal manner.

5. A video display deflection apparatus according to claim 4 wherein said second deflection field includes a portion that varies in a flyback manner.

6. A video display deflection apparatus according to claim 1 wherein said display screen has one of an aspect ratio of 4 by 3 and an aspect ratio of 16 by 9.
